(19) United States
(12) Patent Application Publication
(10) Pub. No.: US 2007/0136120 A1
(43) Pub. Date: Jun. 14, 2007

(54) System and method for providing service

(76) Inventors: Tohru Watanabe, Kawasaki (JP); Shigetoshi Sameshima, Machida (JP); Naoko Saito, Tokyo (JP)

Correspondence Address: MCDERMOTT WILL & EMERY LLP, 600 13TH STREET, N.W., WASHINGTON, DC, 20005-3096, US

(21) Appl. No.: 11/604,874

(22) Filed: Nov. 28, 2006

(30) Foreign Application Priority Data
Nov. 28, 2005 (JP) 2005-341357

(51) Int. Cl. G05B 19/418; G06F 9/46

(52) U.S. Cl. 705/8

(57) ABSTRACT

A service providing system connected to clients comprises an acquisition unit for acquiring first data that indicates a clients' operating status; a prediction unit for predicting the failure of facilities owned by the clients based on the first data; and an output unit for outputting second data indicating resources for restoring the facilities based on the result of damage prediction.

### INCORPORATION BY REFERENCE

The present application claims priority from Japanese application JP 2005-341357 filed on Nov. 28, 2005, the content of which is hereby incorporated by reference into this application.

### BACKGROUND OF THE INVENTION

The present invention relates to a system for providing services in a fair and efficient manner.

In supplying services (use of electric power, gas, heat, water supply, sewage, or the like, communication, broadcasting, or the like), it is important to appropriately provide resources (materials and equipment, funds, labor force, or the like) in preparation for possible accidents and disasters. For that purpose, various estimates and plans are made based on such in-house data as contract information between service providers (suppliers) and customers (consumers) as well as facility information. Accidents and disasters in electric power supply services possibly include, for example, power failures due to defective facilities, harmonics affecting electric power quality, voltage flicker, instantaneous voltage reduction, or the like.

In a Japanese Laid-open Patent Application JP-A-2002-297811, there are described data on deterioration in equipment, as well as a technique of calculating funds necessary for maintaining facilities.

However, the technique described in the Japanese Laid-open Patent Application JP-A-2002-297811 is not able to provide services (minimization of disasters, compensation for secondary disasters, or the like) quickly when secondary disasters occur. As used herein, the term secondary disaster is to be construed as a new disaster (damage) that occurs because necessary services are not provided. For example, if power failures occur in a company that manufactures products, the manufacturing company can not use electric power (primary disaster). As a result, the manufacturing company experiences such a new loss (secondary disaster) as a decline in sales because they can not perform planned manufacturing activity during the time.

### SUMMARY OF THE INVENTION

Therefore, it is an object of the present invention to provide a system and method for enabling the provision of services against secondary disasters quickly.

The present invention is characterized in that it identifies clients' facilities that are affected by the failures, and estimates the effect the failures have on the clients' manufacturing facilities as well as resources necessary for restoring the function of the clients' facilities. Moreover, the present invention is characterized in that it obtains the operational status of the clients.

According to the present invention, not only the effects the failures have on the clients' facilities but also the effects the failures have on the products manufactured by the clients using the facilities are predicted, thus making it possible to provide quick services against secondary disaster (e.g. compensation). Furthermore, the present invention allows the resource amount necessary for restoring defective facilities to be calculated, thus enabling the quick provision of services (e.g. compensation) against the secondary disasters.

### BRIEF DESCRIPTION OF THE DRAWINGS

FIG. 1 is a block diagram of a service providing system;

FIG. 2 is a flowchart of the service providing system;

FIG. 3 is a view showing an input screen;

FIG. 4 is a flowchart of step 22;

FIG. 5 is a flowchart of step 23;

FIG. 6 is a flowchart for when outputting a resource providing policy in case of emergency;

FIG. 7 is a view showing a table relating to the data of a company group;

FIG. 8 is a view showing a table in which necessary resources for each month are predicted;

FIG. 9 is a view showing a table in which the priority of companies in case of emergency is outputted;

FIG. 10 is a view showing a table in which compensation for companies is determined;

FIG. 11 is a block diagram of a company's premise;

FIG. 12 is a block diagram of an authentication data store; and

FIG. 13 is a view showing a table relating to the rule of reading storage device.

### DESCRIPTION OF THE EMBODIMENTS

### Embodiment 1

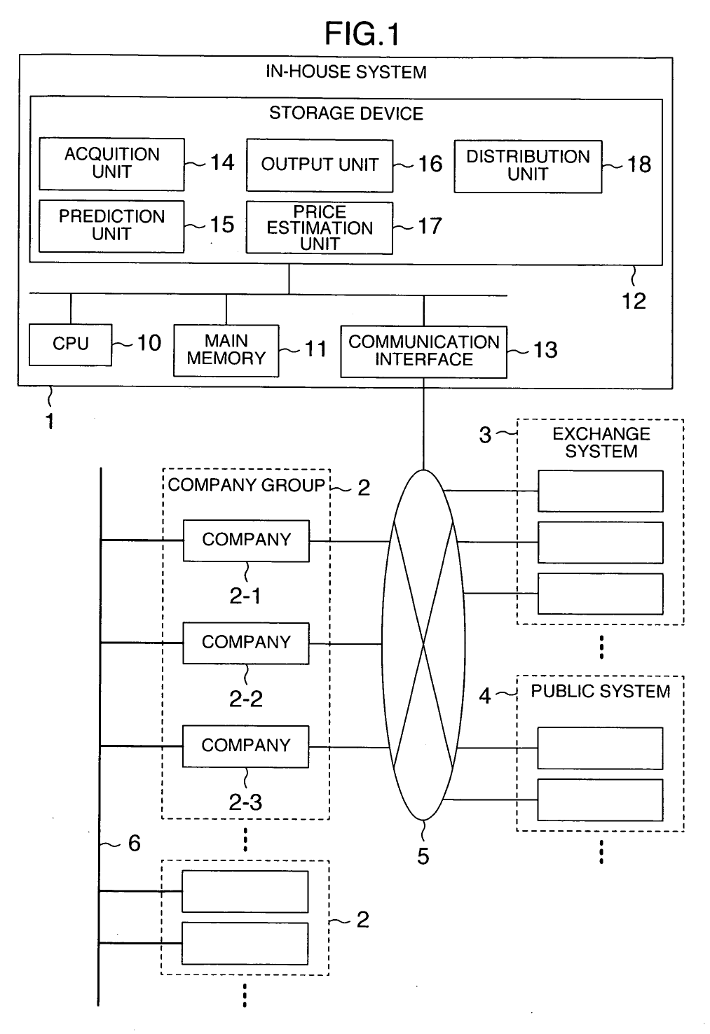

FIG. 1 is a block diagram showing a service providing system. It should be noted that in the present embodiment a description is given assuming that service providers are electric power companies, the service content is an electric power supply, and customers (clients) are companies, however there is no limitation to them. For example, the clients are thought to be companies, organizations, individuals, or the like that receive the services.

The present system comprises a in-house system (electric power company) 1, a company group 2 (comprising companies 2-1 to 2-3), an exchange system 3, a authentication system 4 where authentication data (price statistics, export and import price statistics, corporate information, or the like) is opened to public, a network 5 for mutually connecting these components, and an electric power supplying network 6 for supplying electric power to a plurality of companies.

The in-house system 1 comprises a CPU 10, a main memory 11, a storage device 12, and a communication interface 13, and they are connected via a bus or the like.

The storage device 12 stores a program that comprises an acquisition unit for acquiring data representing operational status of the company group or companies (referred to as authentication data hereinafter); a prediction unit for predicting failures of the facilities owned by the companies based on the authentication data; an output unit for outputting data representing resources (material and equipment, funds, labor force, or the like) necessary for restoring the facilities based on the failure prediction result; an estimation unit for estimating the prices of products manufactured by the companies; an distribution unit for distributing resources for reducing the failures of the company group or the like. It should be noted that the operational status indicates a status in which electric power is used, and products or the like are manufactured. Preferably, the data representing the operational status comprises two kinds of data, data representing electric power use status and data representing manufacturing status of products or the like.

The companies' products refer to tangible products such as industrial products, and intangible products such as public-interest services, public services, and intermediation of commercial transactions.

The CPU 10 performs processing by reading the foregoing programs from the storage device 12 into the main memory 11 for execution.

The above described functions may be implemented by hardware. The program for implementing above functions may also be transferred from storage media such as CD-ROM or the like, or may be downloaded from other devices via a network.

It should be noted that the electric power company typically comprises a business resource management system, a cooperation management system, a sales information system, and an equipment maintenance system. If this structure is applied to the present embodiment, the business resource management system predicts the resources necessary for the contracts and maintenance based on in- and out-house data to organize preparation and operation of resources, which is characteristic of the present embodiment. The cooperation management system cooperates with each system to collect data group as required that is used by the business resource management system. The sales information system make contracts with companies, charges monthly rates, and performs account settlement processing. The equipment maintenance system monitors the status of the electric power facilities, uses given resources to maintain the electric power equipment in an operable state, and organizes and instructs maintenance operations for restoring failures, defects, or the like.

For example, commodity products, industrial products, electric power, or the like are listed in the exchange system 3.

The electric power supply network 6 comprises electric power facilities such as a transformer, a breaker, a distribution line, a power transmission line, a reactive voltage compensation apparatus, a storage battery, and generating equipment.

Parts, half-finished products, finished products, or the like are transported, bought and sold between companies by the mechanism of transportation, warehouse and finance (not shown).

It should be noted that companies 2-1 to 2-3 may be geographically separated from each other as far as each of them is located in one premise where power is supplied. A system comprised of calculators or the like exists in the one premise. The companies within the same company group manufacture finished products in cooperation under the same capital.

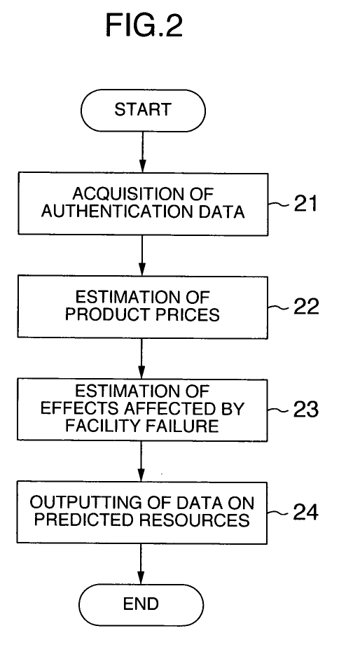

FIG. 2 is a flowchart of a service operating system. While in the following section a description is given in such a way that as if functional modules shown in FIG. 1 are hardware (as if functional modules act as processing bodies), it is needless to say the CPU 10 predominantly implements the program when the functions are implemented by software.

The acquisition unit 14 acquires authentication data (step 21) inputted by persons (company employees, employees commissioned by a company, or the like) via the network 5.

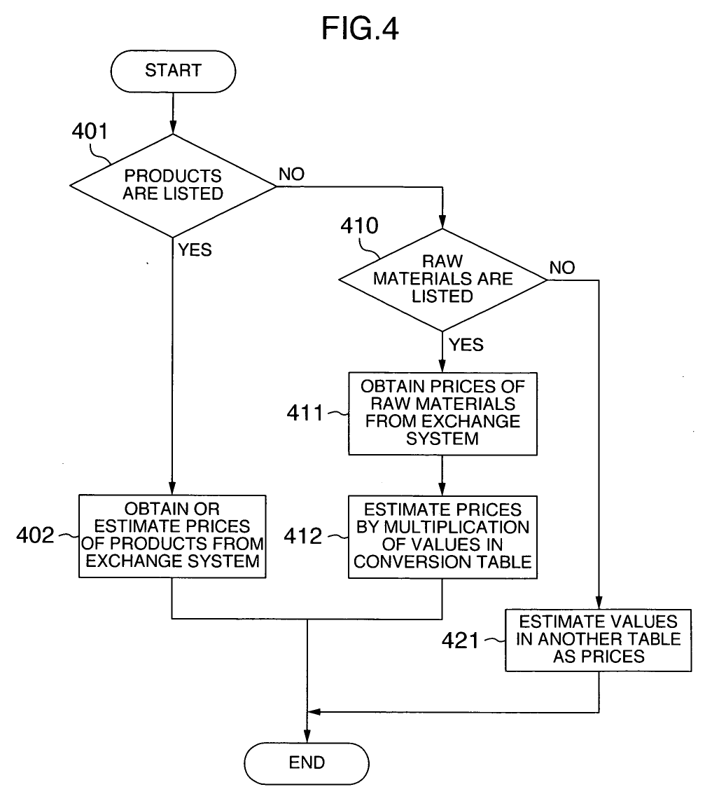

Then, the price estimation unit 17 estimates the prices of the products manufactured by the company group 2 (step 22, detailed description is provided in FIG. 4). In the present embodiment, the authentication data shall be referred to as the data on manufacturing process (supply chain) of the products manufactured by the company group.

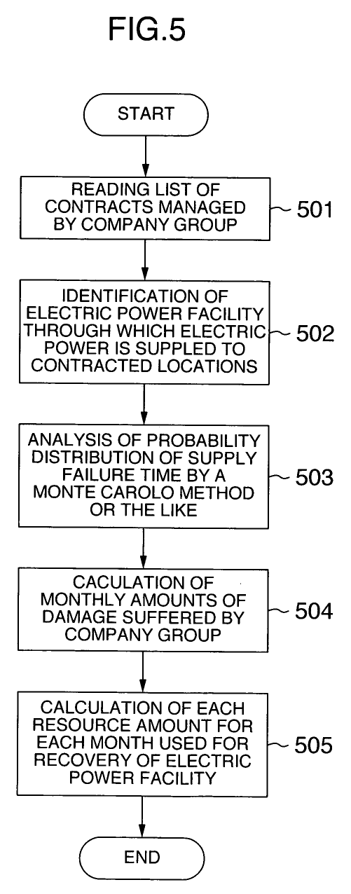

Then, the prediction unit 15 predicts the effects the failure of the electric power facilities have (step 23, detailed description is provided in FIG. 5). The prediction unit 15 predicts resources such as funds necessary for compensating the companies, material and equipment necessary for restoring the function of the facilities, and labor force for each given period (monthly here).

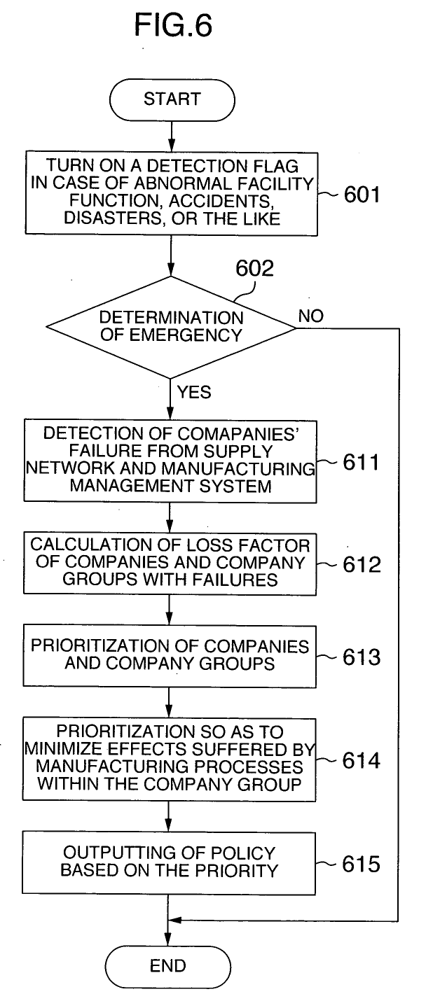

Next, the output unit 16 outputs data of the predicted resources, in other words, the prediction results for each given time of the resources such as funds necessary for compensating companies, materials and equipment necessary for restoring the function of the facilities, and labor force onto an in-house input/output device (not shown) (step 24). The electric power company deposits funds required to make a payment to the company in future, stockpiles an inventory of materials and equipment, and makes labor scheduling based on the outputted data. The output unit 16 also outputs a resource operation policy in case of emergency (described in detail in FIG. 6). When an accident or a disaster that causes supply failure, or a deterioration in the function of the facilities is detected or inputted in real time, a policy is outputted that instructs which facilities or companies should be prioritized in using the resources that are outputted at step 24 based on the authentication data.

In the present embodiment, the company group 2 is assumed to manufactures raw materials, half finished products made of the processed raw materials, and finished products. For example, a company 2-1 manufacturers rubber sheets (RSS (smoked sheet)), a company 2-2 manufactures half finished products made of the processed rubber sheets, and a company 2-3 manufactures and sells tire products. The rubber sheet is listed on the exchange system 3 and their prices per kilogram are publicly announced. Therefore, it is possible to obtain price data from the exchange system 3 by a predetermined protocol via the network 5.

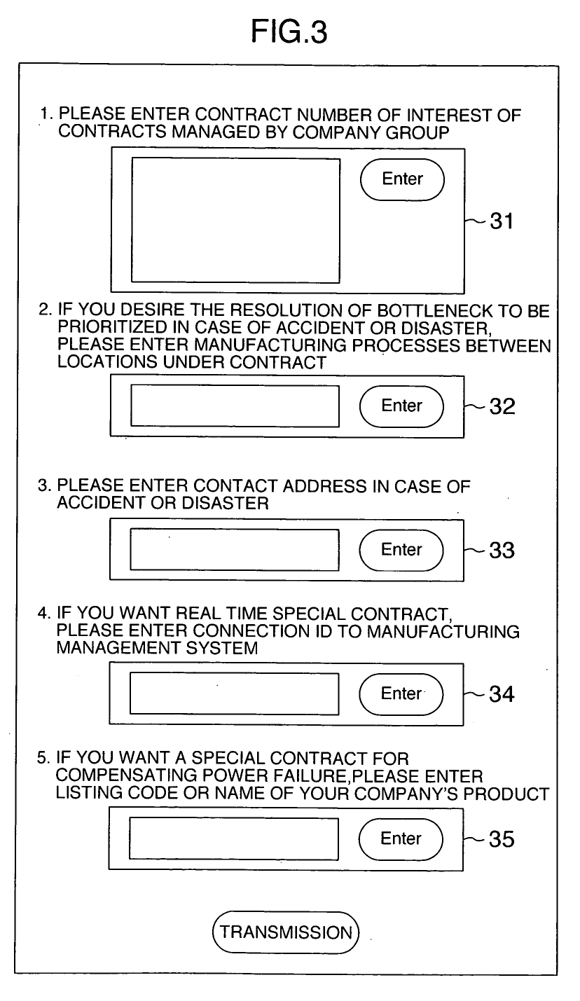

FIG. 3 is an exemplary screen for inputting authentication data at step 21.

An edit box 31 is a field for entering a contract number for each contract of the company group. Note that each contract is indicated by the account number and contract number that are provided in a supplier's system during contract conclusion.

An edit box 32 is a field for entering manufacturing processes between companies within the same company group. In the present embodiment, contract numbers N1211, N1212, N1213 for each company 2-1, 2-2, 2-3 is sequentially inputted.

An edit box 33 is a field for entering contact addresses in case of emergency.

An edit box 34 is a field for entering a connection ID for accessing a manufacturing management system (described in detail in embodiment 2) for managing data (products in process, inventory quantities of products, inventory quantities of materials, or the like) on the products of each company.

An edit box 35 is a field for entering a listing code of the product of each company when the product is listed, or the name of the product when the product is not listed.

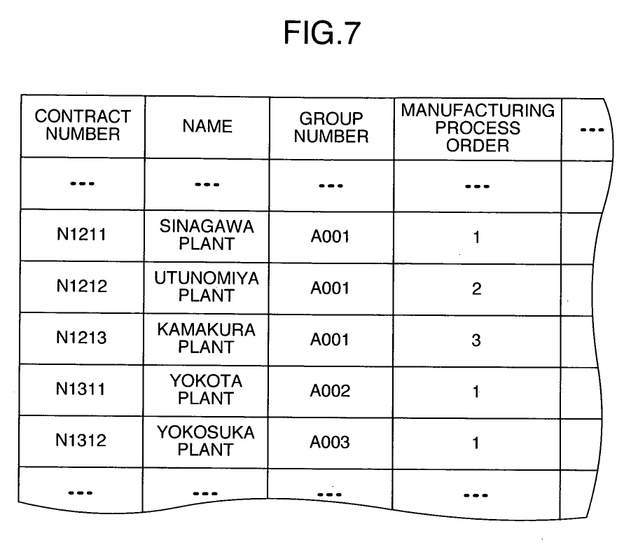

A group number is given to the company group based on the entered information, and is stored in the storage device 12 as data for a table shown in FIG. 7.

FIG. 4 is a flowchart for step 22.

The price estimation unit 17 checks whether a product manufactured by the company group is listed or not (step 401). If the product is listed, the price estimation unit 17 obtains price data for the product from the exchange system to set the price as an estimated value of the price (step 402).

When the product is not listed, the price estimation unit 17 checks whether a raw material of the product is listed or not (step 410). If the raw material is listed, the price estimation unit 17 obtains raw material price data from the exchange system. Then, the price estimation unit 17 multiplies the raw material price data by a value in a conversion rate table which is previously created based on industry category and cost ratio of the product to set the result as an estimated value of the price (step 412).

When the raw material is not listed, the price estimation unit 17 sets a value in another table, in which the price of the product manufactured by the company is related to such economic indicators as a price index, as an estimated value of the price (step 421).

As thus far described, processing shown in FIG. 4 enables the estimation of prices of the products manufactured by the company group.

FIG. 5 is a flowchart for step 23.

The prediction unit 15 reads data on the contract that is managed by the company group (step 501), and identifies electric power facilities (power distribution system facility, transformation facility or the like) through which electric power reaches the company having the contract from among the electric power supply network 6 (step 502).

Then, the prediction unit 15 analyzes the facilities, which are identified at step 502, by failure probability method that complies with a secular parameter or the like, such as a Monte Carlo method, to obtain probability distribution of time, during which the supply of electric power to the contracted facilities is failed, for each month (step 503). It should be noted that the Monte Carlo method refers to a calculation technique for performing a number of simulations using random numbers to obtain an approximate solution. The failure probability is defined in advance for each facility and is stored.

Then, the prediction unit 15 calculates a damage equivalent per supply failure time (e.g. entire amount of products per supply failure time) based on the prices of the products that are calculated at step 22, and multiplies this by probability provided from the probability distribution of the above supply failure time to calculate an average loss amount of the company group for each month (step 504).

Then, the prediction unit 15 refers to a resource management table, in which materials, mechanical equipment, and labor force required for widening the function of the electric power facilities are defined for each electric power facility (for each facility number) in advance to calculate a resource amount (mechanical equipment, materials, and labor force) necessary for restoring the function of the electric power facilities identified at the step 502, and multiplies the resource amount by probability based on the probability distribution of the supply failure time to calculate an average resource amount required for each month (step 505). For the mechanical equipment, materials, and labor force, equivalent monetary values may be used. Input and storage in the resource management table are preferably performed by users in advance.

As thus far described, the processing of FIG. 5 enables the monthly estimation of funds necessary for compensating the damages suffered by the company group, which are calculated at step 504, and of materials, equipment as well as labor force necessary for restoring the function of the electric power facilities, which are calculated at step 505.

FIG. 6 is a flowchart when outputting a resource operation policy in case of emergency.

The distribution unit 18 turns on a detection flag when a failure is occurring in the electric power supply because of abnormal facilities, when a failure sensor or a seismometer detects a large scale accident or disaster, or when an operator inputs an emergency input (step 601). Note that the detection flag is stored in a memory on the CPU 10.

Then, the distribution unit 18 determines whether there is an emergency or not from the turn-on status of the detection flag (step 602), and if there turns out to be an emergency, the following steps are performed:

First, a company group is detected that is now suffering from the failure. For example, a company that is experiencing a supply problem (power failure, instantaneous power failure, voltage reduction, or the like) due to an abnormality in the electric power facilities is determined as a company suffering from the failure (step 611). In the present embodiment, data on failures that affect production is obtained from the company's manufacturing management system, which is entered via the edit box 34.

Next, loss factors for the company and company group that are experiencing problems are calculated (step 612). The loss factors are damage equivalents per supply failure time that are calculated based on the prices of the products of the company which are calculated at step 22. The loss factors of the company group are represented by the damage equivalents per supply failure time calculated based on the prices of the finished products manufactured by the company group.

Next, the companies and company groups are sorted in descending order of the calculated loss factor (step 613).

Next, each company of the company group is prioritized. In this event, data on each product is obtained from the manufacturing management system of each company that is entered from the edit box 34 and prioritization is performed to minimize the effect on the production process of the company group (step 614). For example, in a case where the company 2-3, which uses half finished products manufactured by the company 2-2 as their raw materials, has insufficient raw materials in stock since the company 2-2 has a small stock of the half finished products to be shipped though it has sufficient raw materials in stock, and the production status of the company 2-2 causes a bottleneck for the entire company group, then the company 2-2 is ranked highest among the company group.

Finally, the decided priority data is outputted as a resource operating policy (step 615). The outputted priority data is used as a parameter for deciding the resource assignment in maintenance planning, and as a parameter for deciding the assignment of compensation to the damages of the companies. It should be noted that the detection flag is turned off on condition that a predetermined time has elapsed.

As thus far described, according to the processing of FIG. 6, the resource use policy is decided as the data for prioritizing the companies in an emergency, and the defective electric power facilities can be effectively restored.

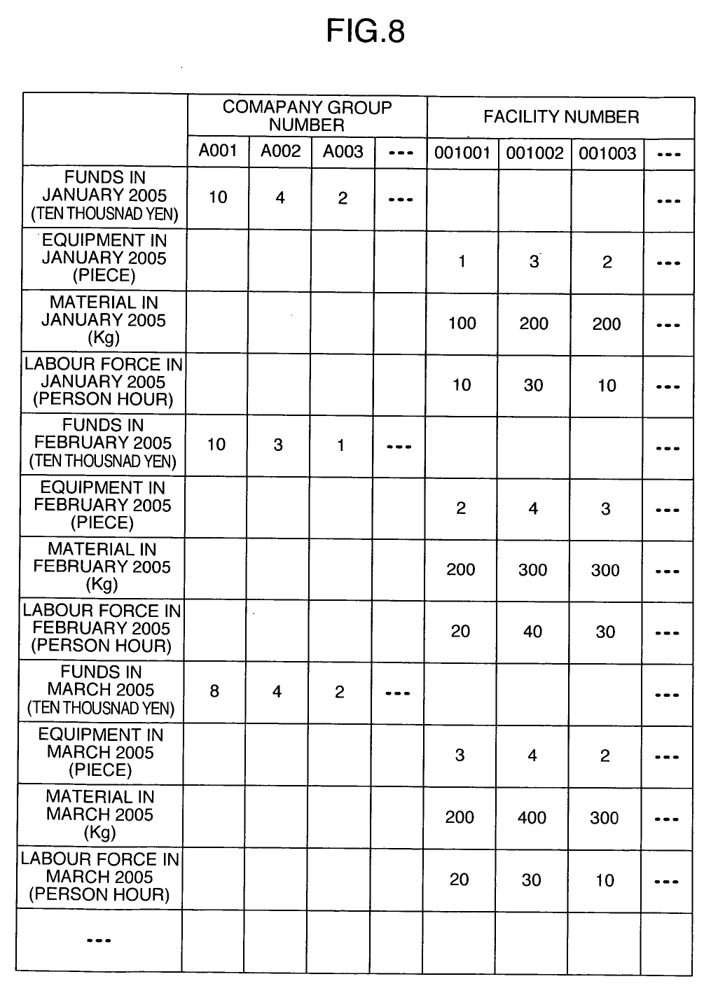

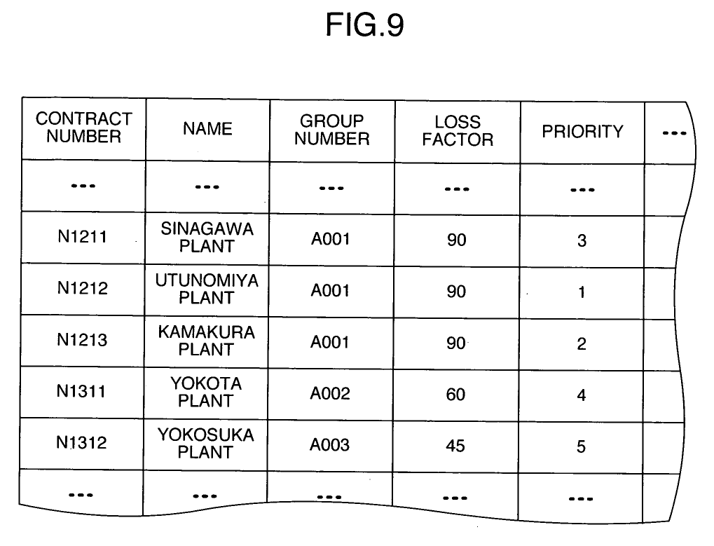

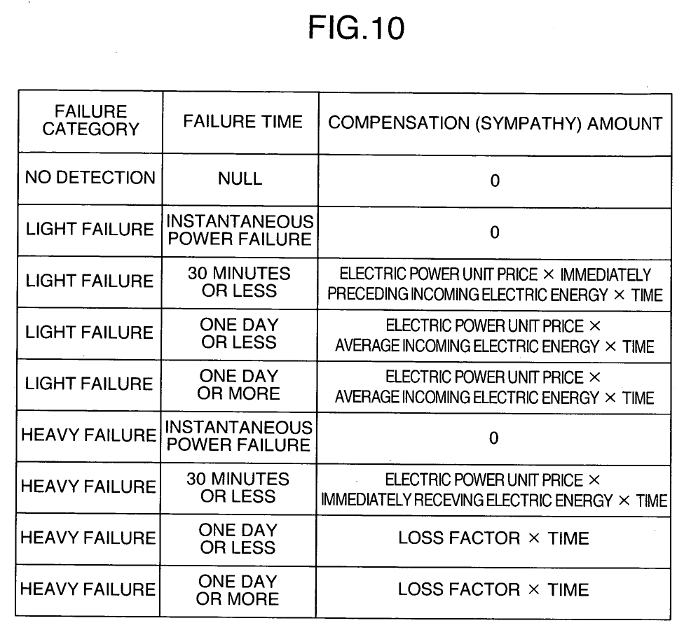

FIG. 8 shows an exemplary output map for predicting the resources that are outputted at step 24 and are required each month. The left field (field of company group number) of FIG. 8 shows an average loss amount of the company group for each month that was calculated at step 504, while the right field (field of facility number) of FIG. 8 shows an average resource amount that is required each month. FIG. 9 shows an exemplary output table of the resource use priority data for each company that serves as a basis for the resource use policy that was decided by the processing of FIG. 6. FIG. 10 shows a table for deciding the compensation (sympathy) amount for the damages suffered by the companies. The priority data is used as a parameter to classify the damages into light and heavy ones. The compensation amount to each company is calculated for each failure duration time according to the expression represented in FIG. 10, which comprises the items: unit price of electric power; immediately preceding incoming electric energy; average incoming energy; loss factor; and time. Then, settlement is made with the company by subtracting the amount.

The foregoing enables the provision of the service for minimizing the effects of accidents, disasters, and failures occurring on the production process of the companies, and the service for compensating a predetermined amount for the damages suffered by the companies.

### Embodiment 2

Embodiment 2 illustrates an example for improving the authenticity of the data content that is obtained from the companies and for improving data confidentiality with respect to outsiders by means of an authentication data store for storing authentication data and control thereof.

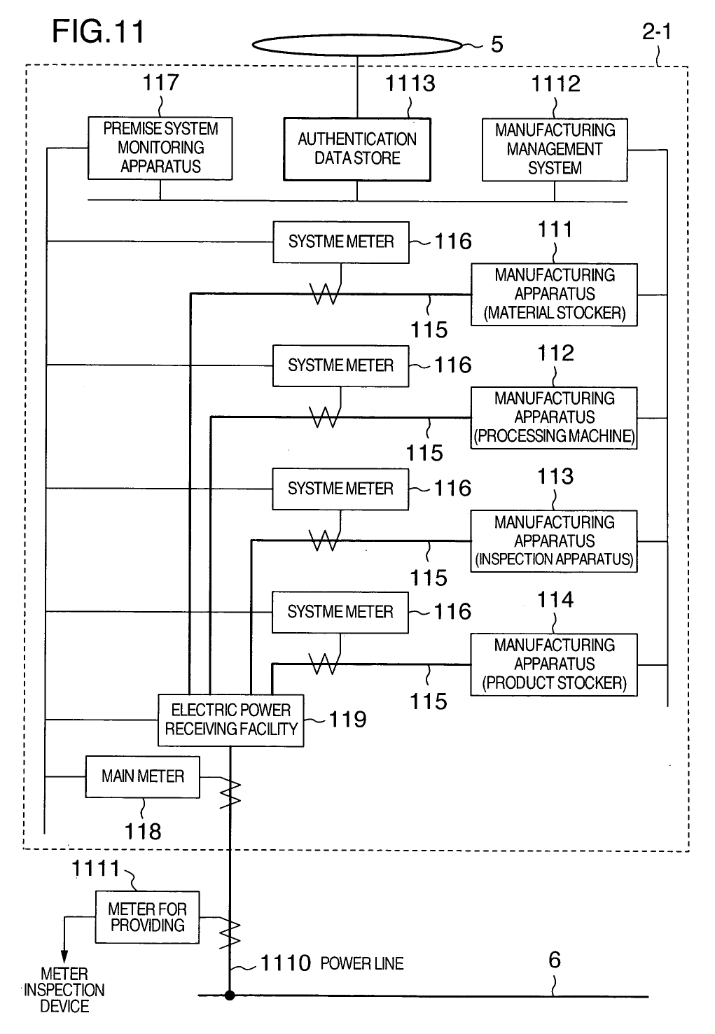

FIG. 11 illustrates an exemplary premise of a company.

The company comprises four manufacturing apparatuses (a material stocker 111, a processor 112, an inspection apparatus 113, and a product stocker 114); a premise system 115 for supplying electric power to these manufacturing apparatuses; a system meter 116 for measuring electric energy consumption; a premise system monitoring apparatus 117 for recording the electric power state (electric energy consumption, power failure, or the like) in the premise for energy management; a main meter 118 for transferring electric energy to the premise system monitoring apparatus 117 via a serial channel; a power receiving unit 119 for transferring the data for failures (power failure on drop wire side, instantaneous power failure, instantaneous voltage reduction, or the like) to the premise system monitoring apparatus 117; a power line 1110; a meter 1111 for measuring electric energy consumption, voltage and frequency to record data with which to ask the company to execute payment for the ordinary transaction; a manufacturing management system 1112 for controlling the four manufacturing apparatuses, which received power supply, to manage the manufacturing state (processing of materials, inspection, stock, or the like); and an authentication data store 1113 for obtaining and continuously recording the authentication data from the premise system monitoring apparatus 117 and the manufacturing management system 1112. The authentication data store 1113 performs encryption communications with the in-house system 1 by a predetermined method.

In the first embodiment, access is directly made to the manufacturing management system in which inputting is made from the screen of FIG. 3, while in the second embodiment, the company data is obtained via the authentication data store 1113, and status data of electric power in the company premise is simultaneously obtained.

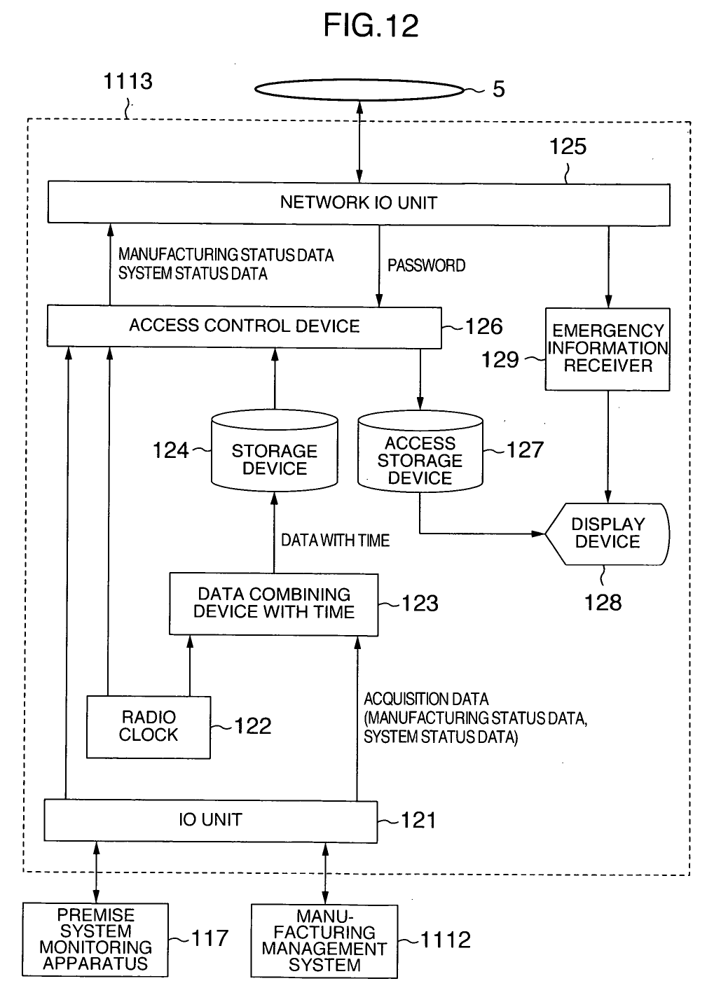

FIG. 12 is a block diagram of the authentication data store 1113.

The authentication data store 1113 comprises an IO unit 121 that is connected to the premise system monitoring apparatus 117 and the manufacturing management system 1112; a network IO unit 125 connected to a network 5; a radio clock 122 for correcting time by radio communication; a data combiner with time for combining the data (data on electric power status and manufacturing status) obtained via the IO unit 121 and time data issued from the radio clock 122; a storage device 124 for continuously storing the combined data; an access control device 126 for limiting access by passwords, for coding telegrams, and for storing in an access storage device 127 the time when access is made, and the time range when data was read out, with the data being attached time information thereto; the access storage device 127 for storing time range of the data with time information attached thereto; and a display device 128 for displaying a list of the access time and read out data time range that are stored in the access storage device 127. Note that a clock having no radio receiving function may be used instead of the radio clock 122. Time correction information may also be obtained via the network IO125.

A preferable embodiment further comprises an emergency information receiver 129 for receiving a list of data with time information attached thereto in emergencies (supply failures, large scale accidents, disasters, earthquakes, operators' determination, or the like). The access time to the storage device 124 as well as the time range of the read-out data with time information attached thereto are correlated to the received emergencies and are displayed on the display device 128. Furthermore, the authentication data store 1113 incorporates a storage battery (not shown), and thereby is able to continue operations and to maintain the communication capability with the network 5 even after external power supply is interrupted. Note that the data of the storage device 124 can be externally accessed via the network IO125.

Moreover, instead of the present embodiment, it may also be possible to obtain the data by connecting the IO121 directly to the premise meters (116, 118), power receiving unit 119, and four manufacturing apparatuses without involving the premise system monitoring apparatus 117 and the manufacturing management system 1112.

The password used at the access control device 126 is set between the supplier of power supply services and companies during conclusion of contracts. The password is held at the storage device 12 of the in-house system 1. The acquisition unit 14 acquires the company data from the authentication data store 1113 via the network 5.

Furthermore, in order to keep the company information (manufacturing status, use status of premise system power, or the like) confidential, accessing conditions to the storage device 124 and time range for data acquisition are arranged between the electric power supplier and the company. The use of the display device 128 enables the recognition of whether access to the storage device conforms to the arrangement.

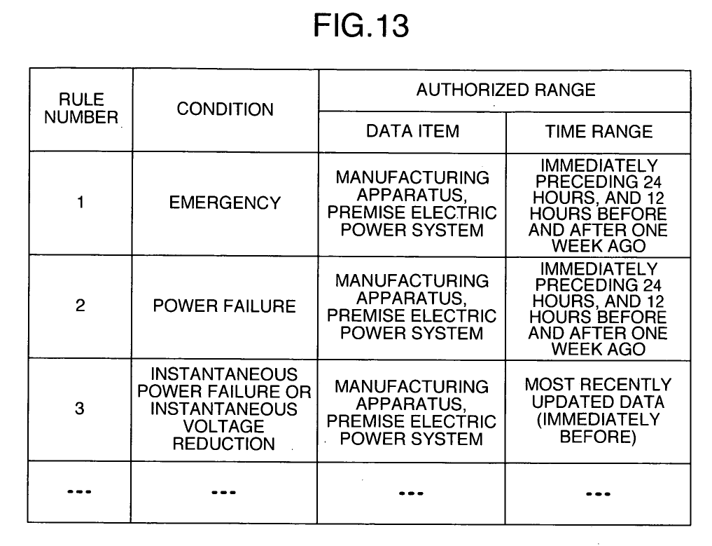

In a preferred embodiment, the access control device 126 has a capability to limit the time range when data is allowed to be read out as well as data items allowed to be read out from the storage device 124 in accordance with a limitation rule. The limitation rule is set following the agreement between the electric power supplier and companies. Its detailed description is shown in FIG. 13 and is as follows:

(1) “If an emergency is detected, access is allowed to the data of the manufacturing apparatus and premise power system during the immediately preceding 24 hours, and 12 hours before and after one week ago”.

(2) “If a power failure occurs, access is allowed to the data of the manufacturing apparatus and premise power system during the immediately preceding 24 hours, and 12 hours before and after one week ago”.

(3) “If an abnormality occurs in the quality of electric power (instantaneous power failure, instantaneous voltage reduction, or the like), access is allowed to the values of the manufacturing apparatus data that are finally updated at a data update time before and nearest to the abnormality occurrence time.”

(4) “Access is allowed on a meter check day to the data relating to the continuity of the premise power system and the operation (ON/OFF) of the manufacturing apparatus from the last meter check date until the present meter check date.”

It should be noted that the meter check refers to reading the value of power energy consumed by the companies, which is measured by a measuring apparatus, via an inspection meter. Moreover, the data relating to the abnormality in the quality of electric power, which is used when imposing a limitation, is obtained via the IO unit 121. Date and time are obtained from the radio clock 122.

The data obtained at the above (1) (2) (3) enables checking the operation status of the company on the day when the electric power failure took place, and the data can be used for planning of the effective recover from the power failure and improvement of facilities. Moreover, the data enables checking if the application for a solatium based on the power use status shown in FIG. 10 was filed properly from both sides of the manufacturing apparatus and premise power system. The data obtained at the above (4) enables checking that the authentication data store 1113 obtained data on the operation of the manufacturing apparatus without fail by comparing two types of data relating to the manufacturing apparatus and premise power system.

In the second embodiment, the details shown in FIG. 6 are changed. More specifically, data is obtained from the authentication data store 1113 at step 611. The data that is obtained from another manufacturing management system is similarly changed to be obtained from the authentication data store 1113.

The present invention is not limited to the foregoing two embodiments. The present invention is applicable to an operation system aiming to maintain durability and inerrancy in the services of network industry that includes electric power, gas, heat, water supply, sewage, communication, broadcasting, and heat supply, which are used for manufacturing purposes by suppliers and customers who are directly connected.

In payment processing in the network, for example, a problem may occur in which the number of payments that can be made is limited due to the saturation of communication channels. However, according to the present system, it is able to process the payment matters in the same order that the company group makes payments, thus making it possible to minimize the delay in operation of the company.

It should be further understood by those skilled in the art that although the foregoing description has been made on embodiments of the invention, the invention is not limited thereto and various changes and modifications may be made without departing from the spirit of the invention and the scope of the appended claims.

1. A service providing system for receiving inputs from clients, the service providing system comprising
an acquisition unit for acquiring said clients' operation status; and
a prediction unit for identifying facilities that are owned by said clients and suffer from the failure based on said clients' operating status to predict the effects that said failure has on the clients' products and resources necessary for restoring the function of said clients' facilities based on said clients' facilities.

2. The service providing system according to claim 1, wherein said clients' facilities comprise electric power facilities, and said clients' operating status comprises the use status of the electric power and manufacturing status of said clients.

3. The service providing system according to claim 1, wherein said acquisition unit acquires the operating status of said clients from said clients' terminal via a network.

4. The service providing system according to claim 1, wherein the acquisition of said clients' operating status is limited to the extent of the facilities within a predetermined time range or associated with the failure.

5. The service providing system according to claim 1, further comprising an estimation unit for estimating the prices of the products manufactured by said clients.

6. The service providing system according to claim 5, wherein when said products are listed on an exchange, said estimation unit estimates the prices of said products based on the prices of said exchange.

7. The service providing system according to claim 5, wherein said estimation unit estimates damages suffered by said clients based on said prices of products.

8. The service providing system according to claim 7, wherein said prediction unit calculates said damages based on loss factors.

9. The service providing system according to claim 1, further comprising a distribution unit for distributing resources so as to reduce said damages.

10. The service providing system according to claim 1, wherein said clients are any of corporations, organizations, or individuals that receive said services.

11. The service providing system according to claim 1, wherein said effects that said failure has on said clients are total amount of the products that could not be manufactured due to said failure.

12. The service providing system according to claim 1, wherein said prediction unit
identifies the electric power facilities that are affected by the electric power failure from an electric power network;
calculates the probability distribution of failure time for each predetermined time by applying a previously defined failure probability corresponding to said identified clients' electric power facilities to a Monte Carlo method, calculates the damages per failure time based on said prices of the clients' products, and calculates the damages suffered by said clients for each said predetermined time by multiplying said damages per failure time by said probability of the probability distribution of the failure time; and
identifies materials, equipment, and labor force necessary for restoring the function of said identified clients' electric power facilities, and calculates the materials, equipment, and labor force for said each predetermined time by multiplying said identified materials, equipment, and labor force by said probability of probability distribution of the failure time, wherein said output unit
outputs said clients' damages for each said predetermined time, and the materials, equipment, and labor force for each said predetermined time.

13. A service providing method for providing clients with services, the service providing method comprising the steps of:
obtaining said clients' operating status;
identifying facilities owned by said clients that suffer from the failure based on said clients' operating status to predict effects that said failure has on said clients' products and resources necessary for restoring the function of said clients' facilities based on said clients' facilities; and
outputting said prediction result.

14. The service providing method according to claim 13, wherein said clients are any of corporations, organizations, and individuals that receive said services.
